(19) United States
(12) Patent Application Publication
(10) Pub. No.: US 2016/0012525 A1
(43) Pub. Date: Jan. 14, 2016

(54) METHOD AND SYSTEM FOR MANAGING RESIDUAL VALUE IN DISTRIBUTED PROCESSING OF TRANSACTIONS

(71) Applicant: Alibaba Group Holding Limited, George Town (KY)

(72) Inventor: Shuo Qiu, Hangzhou (CN)

(73) Assignee: ALIBABA GROUP HOLDING LIMITED, George Town (KY)

(21) Appl. No.: 14/797,577

(22) Filed: Jul. 13, 2015

(30) Foreign Application Priority Data
Jul. 14, 2014 (CN) 201410333960.X

(51) Int. Cl. G06Q 40/00

(52) U.S. Cl. CPC G06Q 40/00

(57) ABSTRACT

A system is provided for facilitating residual-value management. During operation, the system stores in a computing system a total value, which corresponds to a total amount of goods or service. The system divides the total value into a number sub-values, and determining that a sub-value is less than or equal to a threshold. In response, the system merges the sub-value into a merged residual-value. Furthermore, the system receives a transaction that indicates a subtraction operation with an associated value. Subsequently, the system allows the merged residual-value to be considered for processing the subtraction operation, thereby reducing residual-value fragmentation.

### RELATED APPLICATION

Under 35 U.S.C. 119, this application claims the benefit and right of priority of Chinese Patent Application No. 201410333960.X, filed 14 Jul. 2014.

### BACKGROUND

1. Field

The present application relates to the field of computer technologies, and in particular, to a method and system for managing residual values in distributed processing of transactions.

2. Related Art

With the advancement of the computer and network technologies, an increasing number of transactions are performed online and processed by databases. In such operations, there often exists a total value, which may represent the total amount of goods, total amount of space, or total amount of funds, among other things. Often, such a total value can experience a large number of subtraction operations within a short period of time. For example, multiple users may concurrently shop on an e-commerce website during a promotional sale, which is offered only during a limited time window. The total number of items of a respective merchandise can be decreased quickly, often based on concurrent transactions initiated from various sources. In another example, a large number of users may apply for online storage space during a special promotion for cloud services. The total available storage space would decrease based on the application received, and each successful application can result in reduction of the total available storage space until all the storage space is used up. In general, a database is used to process such transactions, and, typically, processing of the transactions can be implemented in two ways:

(1) Centralized management: A single database record is used to store the total value (which may correspond to the total number of items, amount of funds, amount of space, or any type of total quantity that is the target for subtraction from online transactions). Operations such as subtraction to this total value and determination of the remaining value are performed by executing, for example, SQL commands in a single database.

(2) Distributed management: The total value is divided into a number of sub-values. Each sub-value is stored in a separate record, optionally at a different database or server. The subtraction operations corresponding to incoming transactions typically undergo a load-balancer server and distributed among these different records. For example, suppose there is a total amount of available storage space of 1000 GB, and each user can apply for 3 GB of free storage space. Correspondingly, the total value can be 1000, and each transaction (i.e., user application for 3 GB of storage space) results in an operation of subtraction by 3. The total value of 1000 can be divided into 10 sub-values, each being 100, and stored in 10 database records. Each subtract-by-3 operation is dispatched by a load-balancer to one of the 10 data records. For example, if an incoming subtract operation is forwarded to sub-value record number 2, the corresponding residual value of this data record becomes 97, while the values of the rest of the sub-value data records remain to be 100. Note that in this disclosure a value indicating the remaining value of a sub-value data record can be referred to as a residual value.

In the first method mentioned above (centralized management), the centralized execution of database commands and I/O operations can result in hot-spot problems. That is, a large number of operations during a short period of time can burden the database system and result in extended wait time and reduced processing efficiency. Furthermore, concentrated processing of a single database record that stores the residual value of the total value can cause a bottleneck in updating this data record and makes the system more prone to update errors.

In the second method mentioned above (distributed management), the incoming operations are distributed to multiple data records. However, because each data record is updated independently, the total residual value can be fragmented among these date records. Using the same example above, if the residual value of each sub-value data record is 1, although the total residual value (sum of residual values of all sub-value data records) is 10, none of the sub-value records can accept further subtraction operations. These residual values that can no longer accept subtraction operations are referred to residual-value fragments. Such fragmentation can be more prominent when the subtraction values vary. For example, if a user can apply for 3 GB, 5 GB, or 15 GB of storage space, because the amount of subtraction of each transaction is unpredictable, it cannot be guaranteed that each sub-value record can eventually be reduced to zero. As a result, a large number of residual-value fragments can be created. Correspondingly, the residual value in multiple sub-value records cannot be utilized and the total residual value cannot be minimized, which can cause waste to the system resource and database storage space.

### SUMMARY

One embodiment of the present invention provides a system for facilitating residual-value management. During operation, the system stores in a computing system a total value, which corresponds to a total amount of goods or service. The system divides the total value into a number sub-values, and determining that a sub-value is less than or equal to a threshold. In response, the system merges the sub-value into a merged residual-value. Furthermore, the system receives a transaction that indicates a subtraction operation with an associated value. Subsequently, the system allows the merged residual-value to be considered for processing the subtraction operation, thereby reducing residual-value fragmentation.

In a variation of this embodiment, the threshold is greater than or equal to a minimum value associated with the subtraction operation.

In a variation of this embodiment, the system selects one from the sub-values greater than or equal to the threshold and the merged residual-value for performing the subtraction operation.

In a variation of this embodiment, the system indicates a sub-value as disabled when a residual value thereof is zero.

In a variation of this embodiment, the system obtains snapshots of records storing the sub-values and merged residual-value. The system then selects a qualified sub-value or the merged residual-value. The snapshot of a qualified sub-value indicates a residual value greater than or equal to the threshold. Responsive to a qualified sub-value being selected, the system applies a lock to the record storing the selected sub-value and performing the subtraction operation on the selected sub-value.

In a variation of this embodiment, the system maintains version information for snapshots of records storing the sub-values and merged residual-values. In addition, the system updates the version information for the corresponding snapshot when a sub-value or merged residual-value is updated.

In a variation of this embodiment, the total value corresponds to an inventory of merchandise. The transaction is a purchase order for the merchandise. Furthermore, the subtraction operation corresponding to the transaction represents a deduction to the inventory as a result of the purchase order.

In a variation of this embodiment, the total value corresponds to a total amount of available storage space. The transaction is a request for allocating a storage space to a user. Furthermore, the subtraction operation corresponding to the transaction represents a deduction to the total amount of available storage space as a result of the allocation.

### BRIEF DESCRIPTION OF THE FIGURES

The accompanying drawings herein, which are incorporated herein and constitute a part of the specification, illustrate several exemplary embodiments of the present application and together with the description, serve to illustrate the present application, construing no limitation to the present application. In the drawings:

FIG. 1A illustrates an exemplary distributed residual-value management system based on sub-value data records, in accordance with an embodiment of the present application.

FIG. 1B illustrates an exemplary merged sub-value data record for distributed residual-value management, in accordance with an embodiment of the present application.

FIG. 2A illustrates a process of generating sub-value data records, in accordance with an embodiment of the present application.

FIG. 2B illustrates a process of managing sub-value data records, in accordance with an embodiment of the present application.

FIG. 2C illustrates a process of asynchronous merging of a sub-value data record, in accordance with an embodiment of the present application.

FIG. 3A is a schematic structural diagram of an exemplary residual-value management system, in accordance with an embodiment of the present application.

FIG. 3B is a schematic structural diagram of an exemplary residual value merging module of a residual-value management system, in accordance with an embodiment of the present application.

FIG. 3C is a schematic structural diagram of another exemplary residual value merging module of a residual-value management system, in accordance with an embodiment of the present application.

FIG. 3D is a schematic structural diagram of an exemplary allocation module of a residual-value management system, in accordance with an embodiment of the present application.

In the figures, like reference numerals refer to the same figure elements.

### DETAILED DESCRIPTION

Embodiments of the present invention solve the problem of managing residual-value fragmentation in distributed transaction processing by dividing a total value into a number of sub-values and when a sub-value is reduced to below a threshold merging such sub-values into a merged sub-value data record, thereby allowing the merged sub-value data record to accept more subtraction operations. Such methods can be used in various applications, such as processing e-commerce transactions and allocating storage spaces. During operation, when a transaction arrives, the corresponding subtraction operation is forwarded to one of the sub-value data records. The transaction amount can be deducted from the corresponding sub-value to indicate the residual value (e.g., remaining inventory or storage space) in that sub-value data record.

If the residual value of a sub-value data record becomes less than (or equal to) a threshold, the residual value of that sub-value data record is merged with a merged sub-value data record and the residual value of the sub-value data record is set to zero. In one embodiment, the state of the sub-value data record is set as “disabled” when the residual value of the sub-value data record is zero. The merged sub-value data record can be a separate data record from the sub-value data records. One of the sub-value data records can also be selected to serve as the merged sub-value data record. The residual value of the sub-value data record is then added to the residual value of the merged sub-value data record to indicate the increased available amount in the merged sub-value data record due to the merger. A value (i.e., the residual value after the addition) indicating the residual value of the merged sub-value data record can be referred to as a merged residual value.

To make the objectives, technical solutions, and advantages of the present application clearer, the technical solutions of the present application are hereinafter described in detail thoroughly with reference to the specific embodiments of the present application and the corresponding drawings. Clearly, the embodiments described herein are merely exemplary ones, but are not all the embodiments of the present application. Based on the embodiments of the present application, all other embodiments derived by persons of ordinary skill in the art without any creative efforts shall fall within the protection scope of the present application.

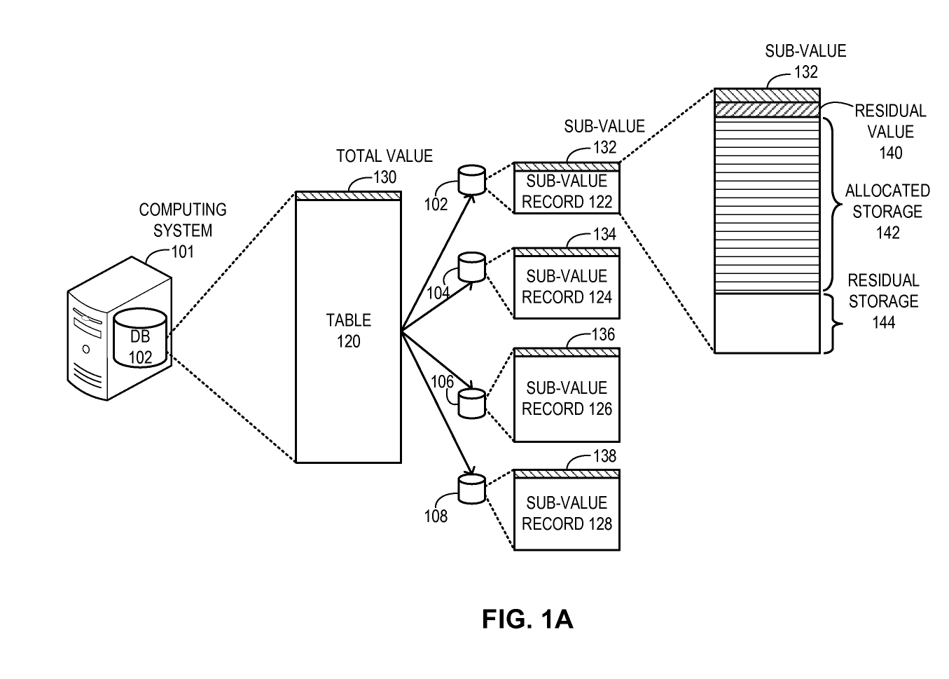

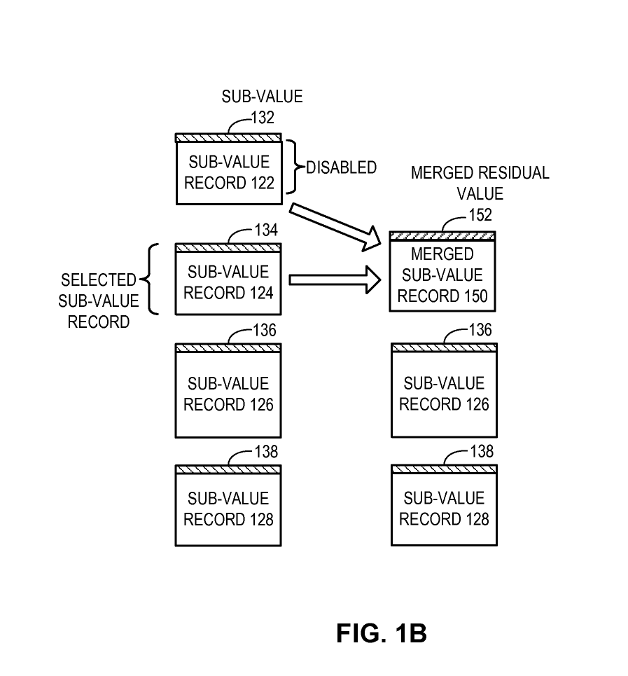

FIG. 1A illustrates an exemplary distributed residual-value management based on sub-value data records, in accordance with an embodiment of the present application. In this example, a computing system 101 includes a database 102 which stores a total value 130 in a database table 120. Total value 130 can indicate the inventory for one or more merchandises, a total storage space, a total amount of funds, or any type of quantity subject to subtraction associated to transactions. When a large number of transactions arrive in a short period of time, total value 130 is deducted accordingly.

If total value 130 is managed using a centralized method, total value 130 can be stored in a single database record. The residual value of this record is calculated in response to a transaction (e.g., through the execution of an SQL statement). However, the centralized management may lead to a hot spot problem as describe above.

On the other hand, if total value 130 is managed using a distributed method, total value 130 can be split into different sub-values, and each sub-value is stored in a separate record. Using the distributed method can reduce the hot spot problem. However, this can lead to the residual-value fragmentation problem. To solve the residual-value fragmentation problem, total value 130 is divided into sub-values 132, 134, 136, and 138, which are stored in sub-value data records 122, 124, 126, and 128, respectively. In some embodiments, sub-value data records 122, 124, 126, and 128 can be stored in databases 102, 104, 106, and 108, respectively. These databases can reside on distinct computing devices or in different database instances hosted on one or more computing devices.

The number of these sub-values may be determined based on total value 130 and a maximum subtraction value associated with the transactions (for example, the maximum storage space a user can apply for, or the maximum number items a user can purchase. The number of the sub-values can be smaller than a divisor obtained by dividing total value 130 by the maximum value associated with user transactions. This limits the number of sub-values, which, in turn, saves storage overhead (e.g., to store configuration data, such as sub-values and residual values) due to excessive decentralization and prevents severe fragmentation of data records due to small sub-values. Furthermore, if the sub-values are uniformly distributed such a way that each sub-value is less than the maximum value associated with a transaction, a transaction with the maximum value may not be processed. On the other hand, if the sub-values are not uniformly distributed, a few sub-values can be significantly larger than the maximum value. As a result, a large number of blank data records may occur.

In some embodiments, the number of the sub-values is determined in such a way that the sub-values are substantially uniformly distributed and each sub-value is greater than a multiple (e.g., two times) of the maximum value associated with a transaction. Hence, sub-values 132, 134, 136, and 138 can be uniformly distributed based on total value 130, and each of these sub-values is greater than a multiple (e.g., an integer multiple) of the maximum value. This configuration allows the system to assign transaction to a respective sub-value data record and use that data record for multiple requests. In this way, the system not only avoids the hot spot problem, but also avoids processing of a large number of sub-value data records. This also allows the deduction time of each sub-value to be close to each other, and hence, the processing of the sub-value data records remains concise. It should be noted that the number of the sub-values may also be selected in such a way that the sub-values are not uniformly distributed but a respective sub-value is greater than a multiple of the maximum value.

During operation, when a transaction is received, the corresponding subtraction operation is allocated from one of the sub-value data records, such as sub-value data record 122. The associated transaction value can be subtracted from sub-value 132 to indicate the residual value 144 (e.g., the remaining inventory, remaining storage space, or any other type of quantity) in sub-value data record 122. In other words, sub-value 132 can indicate the residual value for sub-value data record 122 and can be referred to as residual value 132 as well. It should be noted that the residual value for sub-value data record 122 can also be maintained as a separate record, such as residual value 140. In this disclosure, the total value and sub-values are not associated with a particular unit, and can be expressed using any suitable unit system (e.g., number of items, amount of currency, units of storage space, etc).

FIG. 1B illustrates an exemplary merged sub-value data record for distributed residual-value management, in accordance with an embodiment of the present application. Suppose that sub-value 132 of sub-value data record 122 becomes less than a threshold. A range of the threshold can be between a minimum value of a transaction value (e.g., a minimum number of items a user might purchase, minimum storage space a user may request, or a minimum amount of funds involved in a transaction) and total value 130. Ideally, the threshold can be greater than or equal to a maximum value associated with a transaction. In some embodiments, the threshold is greater than the maximum value associated with a transaction and less than twice that maximum value. This ensures that if a transaction with the maximum value arrives at the system, the residual value of at least one of the sub-value data records is sufficient to serve the request.

If sub-value 132 becomes less than the threshold due to prior transactions dispatched to sub-value data record 122, sub-value 132 can be merged into a merged sub-value data record 150. Sub-value 132 can then be set to zero. The state of sub-value data record 122 is set as “disabled” if the residual value of sub-value 132 is zero. Sub-value 132 can also be merged with merged into sub-value data record 150 if sub-value 132 is less than a value associated with a transaction. For example, if sub-values are randomly distributed based on total value 130, one or more sub-values can be relatively small while others can be large. As a result, sub-value 132 can be less than the value associated with a transaction. In response, sub-value 132 can be merged with merged sub-value data record 150.

Merged sub-value data record 150 can be an additional data record (i.e., separate from the sub-value data records) with an initial residual value of zero, or a pre-selected sub-value data record, such as sub-value data record 124. To serve as merged sub-value data record 150, the system can select sub-value data record 124 randomly or because sub-value data record 124 has the minimum residual value among the sub-value data records. Merged sub-value data record 150 can be determined at a time before the assignment of the transaction. When sub-value data record 122 is merged with merged sub-value data record 150, the residual value of sub-value 132 is added to the residual value of merged sub-value data record 150. The residual value of merged sub-value data record 150 can be referred to as merged residual value 152. After the addition, merged residual value 152 indicates the sum of sub-value 132 and sub-value 134.

In some embodiments, after sub-values 132, 134, 136, and 138 are computed and stored, the system scans a respective sub-value data record to identify the sub-value data records with a residual value less than the threshold, and merges the identified sub-value data records into merged sub-value data record 150. This merger can occur before processing a transaction by a sub-value data record. Since different applications often simultaneously initiate transactions (e.g., multiple users rush to purchase merchandise at the same time), the transaction processing and mergers can be performed simultaneously (e.g., by different threads). The system then determines whether the residual value of a sub-value data record is less than the threshold, and if so, the residual value of the sub-value data record is merged with merged sub-value data record 150.

Suppose that sub-value data records 122 and 124 are merged to create merged sub-value data record 150. When a transaction is received, the system considers sub-value data records 126 and 128 as well as merged sub-value data record 150 for processing the transaction. This reduces total residual value and residual-value fragmentation. The system first considers one of sub-value data records 126 and 128 for the assigning the transaction. If the system cannot assign the transaction to these sub-value data records (e.g., due to insufficient sub-value) or the residual values of the sub-value data records are zero (i.e., all sub-value data records have been merged), the system can then assign the transaction to merged sub-value data record 150. However, this can lead to the hot spot problem due to centralized allocation from merged sub-value data record 150.

To avoid this potential problem, in some embodiments, the system can randomly select between a sub-value data record with sufficient residual value (i.e., with a residual value greater than the threshold), and merged sub-value data record 150 for assigning the transaction. During the assignment, the system selects one of the sub-value records 126 and 128, which has a residual value greater than the threshold, for assignment. Suppose that sub-value data record 128 is selected. Based on a selection process (e.g., random selection), the system then selects either sub-value data record 128 or merged sub-value data record 150 for allocation. After the assignment, if the residual value of sub-value data record 128 becomes less than (or equal to) the threshold, the residual value of sub-value data record 128 is merged with merged sub-value data record 150.

It should be noted that sub-value data record 128 and merged sub-value data record 150 should be in an enabled state. Typically, the enabled state is the default state for a data record. If sub-value data records 126 and 128 are in a disabled state, available residual value of a respective sub-value data record has been used or merged. As a result, only merged sub-value data record 150 may be selected. When merged residual value 152 becomes less than the maximum value of a transaction, such a transaction with the maximum value may not be assigned. Finally, when merged residual value 152 becomes less than the minimum value of a transaction, transaction assignment can be terminated. At that point, the total residual value can be the minimum.

In some embodiments, during the transaction assignment, while selecting a data record, the system obtains a respective snapshots of sub-value data record 128 and merged sub-value data record 150 to determine the residual value. The snapshot of a sub-value data record can indicate the residual value of that sub-value data record. The snapshots can be generated by a database snapshot function. It should be noted that this example is described based on the respective snapshots of sub-value data record 128 and merged sub-value data record 150. However, the system can generate and maintain snapshots of a respective sub-value data record.

In some embodiments, a respective sub-value data record and merged sub-value data record 150 can be associated with a version number, which indicates the current version of the data record. Furthermore, a snapshot can also include a version number. Examples of the version number include, but are not limited to, a timestamp or a monotonically incremental integer. To avoid the hot spot problem, a snapshot and the corresponding data record are typically stored in different databases. As a result, the update sequence of the snapshots may not be consistent with the update sequence of the corresponding data record. By comparing the version number of the snapshot and the version number of the corresponding sub-value data record (or the merged sub-value data record), the system ensures the consistency of the snapshots.

In some embodiments, the system updates a snapshot of a sub-value data record, such as sub-value data record 128, or merged sub-value data record 150, in response to a transaction (e.g., a change to the residual value) or a merger of the data record. The snapshot update process can include updating a version number (e.g., adding the most recent time stamp or incrementing an integer value). For example, if a transaction has been processed by sub-value data record 128, the system updates the version number of sub-value data record 128. The snapshot update process can further include updating the snapshot of sub-value data record 128. If the version number of the snapshot is less than the version number of sub-value data record 128, the system generates a new snapshot of sub-value data record 128 and updates the version number of the snapshot.

If the snapshot of sub-value data record 128 is updated each time a transaction is processed by the corresponding sub-value data record 128, the database hosting the snapshot might suffer from the hot spot problem. Since a transaction can be processed by sub-value data record 128 if the residual value of sub-value data record 128 is greater than or equal to the threshold, the snapshot may not carry a specific numerical value of the residual value. The snapshot can include an indicator (e.g., a binary value) which indicates whether the residual value is “greater than or equal to the threshold (≧threshold).” In other words, the indicator indicates whether sub-value data record 128 is “available for transaction assignment.” If the residual value of sub-value data record 128 is less than the threshold, sub-value data record 128 is merged with merged sub-value data record 150 and the residual value is set to zero. Hence, if the indicator indicates that sub-value data record 128 is “not available for transaction assignment,” the residual value of sub-value data record 128 is actually zero. Therefore, the indicator is sufficient for determining whether the snapshot should be updated. Thus, in some embodiments, the respective snapshots of sub-value data record 128 and merged sub-value data record 150 are updated when sub-value data record 128 is merged with merged sub-value data record 150. It should be noted that the system still compares the version numbers of a snapshot and the corresponding sub-value data record to determine whether the snapshot should be updated.

The following example further illustrates residual-value management based on sub-value data records. Suppose that the residual values of sub-value data records 122, 124, 126, and 128 are 0, 22, 15, and 17, respectively, and the threshold value is 10. Hence, the state of sub-value data record 122 is disabled. During operation, a transaction with a value of 6 (e.g., a user order 6 items, or applying 6 GB of storage space) from an application arrives at the system. The system inquires the snapshots of the sub-value data records and determines that sub-value data records 124, 126, and 128 are enabled. The system then randomly selects sub-value data record 126 for the transaction. Before initiating any transaction on database 106 of sub-value data record 126, the system locks (e.g., using a distributed semaphore) the residual value record, which can be sub-value 136, of sub-value data record 126. This lock ensures that no other entity can update the record until the lock is released.

Since the residual value of sub-value data record 126 is 15, the system deducts the requested value of 6 from the residual value and updates the residual value to 9. The system then determines that the current residual value of 9 is less than the threshold of 10. The system in turn initiates a merging service with a merging value of 9 and sets the state of the merging service as INIT, which indicates an initial state. The system sets the residual value of sub-value data record 126 to 0 and sets the state of sub-value data record 126 to disabled. Optionally, the system then can submit the corresponding transaction to database 106. This database transaction can be a conventional database operation and is a basic program element of database processing. Thus, whether the database transaction is expressed in the process or not does not influence the principle and application of the present application.

At this point, the sum of the residual values of the sub-value data records is 0+0+17+22=39, and after deducting the requested value of 6 from the total residual value of 54, the resultant total residual value should be 48. The difference in total value, 54−48=9, is recorded as a parameter of the merging service. The system can initiate an asynchronous merging process which merges the residual value of sub-value data record 126 with merged sub-value data record 150. The system can also initiate a snapshot update process, as described in conjunction with FIG. 1B. During the asynchronous merging process, the system obtains the parameter indicating that a storage capacity of 9 should be added to merged sub-value data record 150, which is sub-value data record 134. The system can optionally start a corresponding transaction on database 104 of sub-value data record 134.

During merging, the system adds the obtained value of 9 to the residual value 22 of merged sub-value data record 150 (i.e., the residual value of sub-value data record 124). Hence, the residual value of merged sub-value data record 150 becomes 31. The system can then change the state of the merging service to SUSS, which indicates a successful completion of the merger. When the merging service reaches the SUSS state, the sum of the residual values of sub-value data record 128 and merged sub-value data record 150 becomes 48.

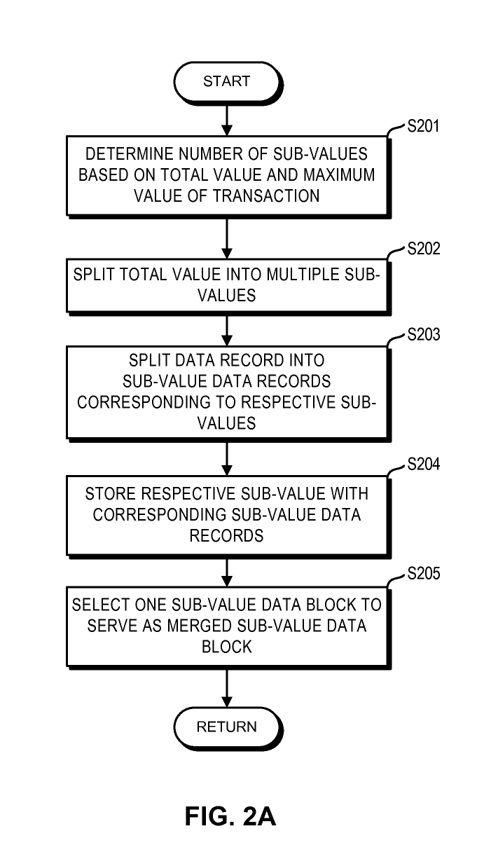

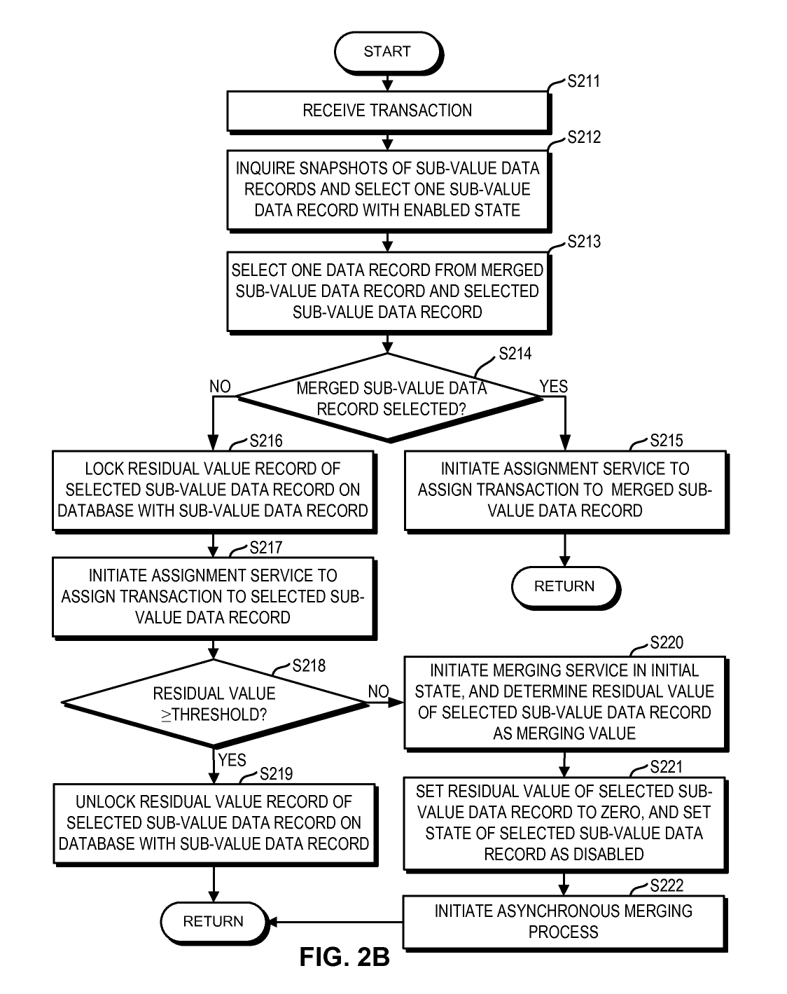

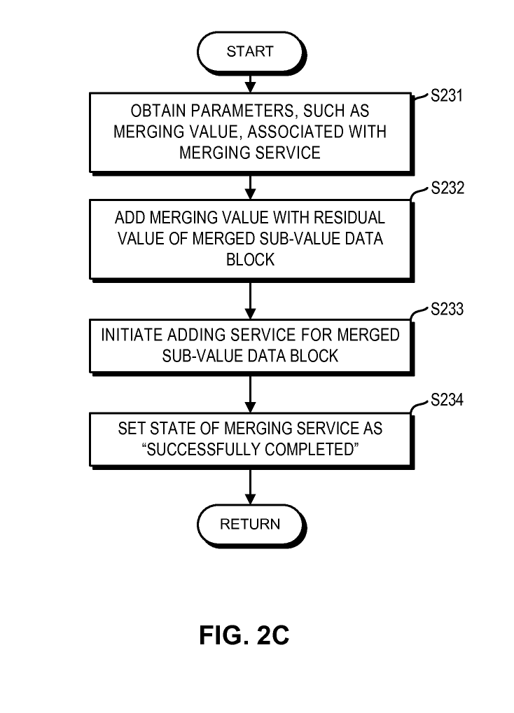

FIG. 2A illustrates a process of generating sub-value data records, in accordance with an embodiment of the present application. During operation, a system for residual-value management determines a number of sub-values based on a total value, and a maximum value of a transaction (operation S201) and splits the total value into multiple sub-values (operation S202), as described in conjunction with FIG. 1A. The system then splits the data record into sub-value data records corresponding to the respective sub-values (operation S203). The system stores a respective sub-value with the corresponding sub-value data record (operation S204). In some embodiments, the system selects one of the sub-value data records to serve as the merged sub-value data record (operation S205). The system can also have a separate data record to serve as the merged sub-value data record.

FIG. 2B illustrates a process of managing sub-value data records, in accordance with an embodiment of the present application. During operation, a system for efficient residual-value management receives a request for an online transaction, such as an e-commerce purchase order specifying a quantity of merchandise (operation S211). The system inquires the snapshots of the sub-value data records and selects one of the sub-value data records with an enabled state (operation S212). Since the threshold is typically larger than the maximum value of the transaction, a sub-value data records with an enabled state typically has sufficient value to process the transaction. The system can select the sub-value data record based on a selection policy, examples of which include, but are not limited to, random selection, maximum (or minimum) residual value-based selection, and round robin selection. The system selects one data record from the merged sub-value data record and the selected sub-value data record (operation S213). The system can select the data record based on a selection policy, examples of which include, but are not limited to, random selection and merged sub-value data record last selection (i.e., selecting the merged sub-value data record if no sub-value data records has sufficient value).

The system then determines whether the merged sub-value data record has been selected (operation S214). If the merged sub-value data record has been selected, the system initiates an assignment service to assign the transaction to the merged sub-value data record (operation S215). If the merged sub-value data record has not been selected (i.e., one of the sub-value data records has been selected), the system locks the residual value record of the selected sub-value data record on the database with the sub-value data record (operation S216). The system then initiates the assignment service to assign the transaction to the selected sub-value data record (operation S217).

The system determines whether the residual value of the sub-value data record is greater than or equal to the threshold (operation S218). If the residual value is greater than or equal to the threshold, the system unlocks the residual value record of the selected sub-value data record on the database with the sub-value data record (operation S219). If the residual value is less than the threshold, the system initiates a merging service in an initial state to merge the selected and merged sub-value data records, and determines the residual value of the selected sub-value data record as the merging value (operation S220). The system then sets the residual value of the selected sub-value data record to zero, and sets the state of the selected sub-value data record as disabled (operation S221), as described in conjunction with FIG. 1B. The system then initiates an asynchronous merging process to merge the residual value of the selected sub-value data record with the merged sub-value data record (operation S222).

FIG. 2C illustrates a process of asynchronous merging of a sub-value data record, in accordance with an embodiment of the present application. During operation, a system obtains the parameters, such as a merging value, associated with the merging service (operation S231). The system adds the merging value with the residual value of the merged sub-value data record (operation S232). The system initiates an adding service for the merged sub-value data record to add the residual value of a selected sub-value data record, as described in conjunction with FIG. 2B, to the residual value of the merged sub-value data record (operation S233). The system then sets the state of the merging service as “successfully completed” (operation S234).

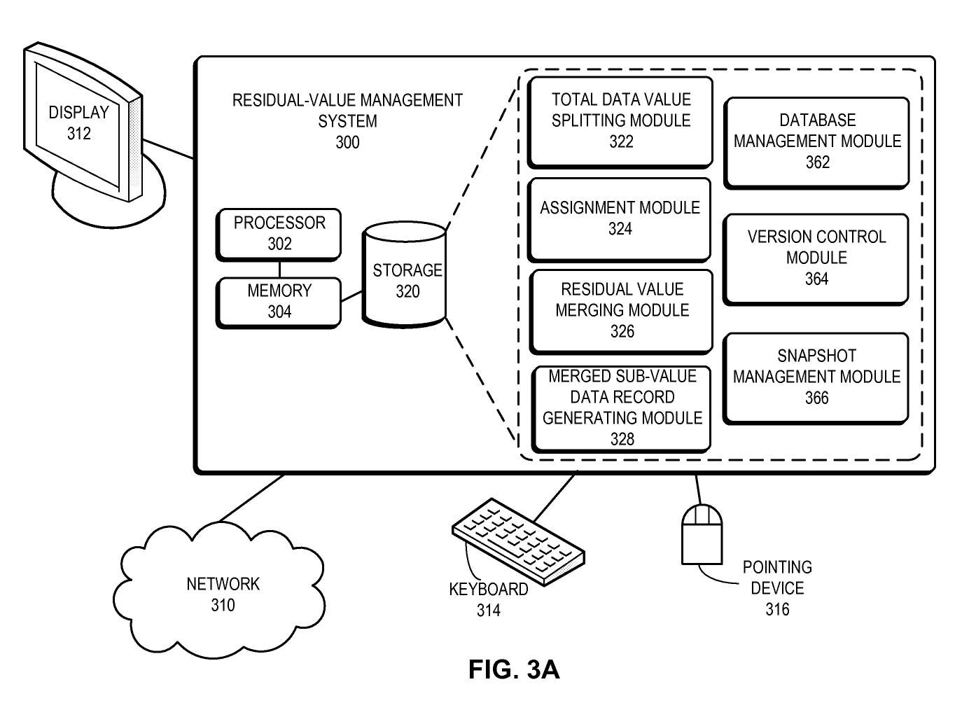

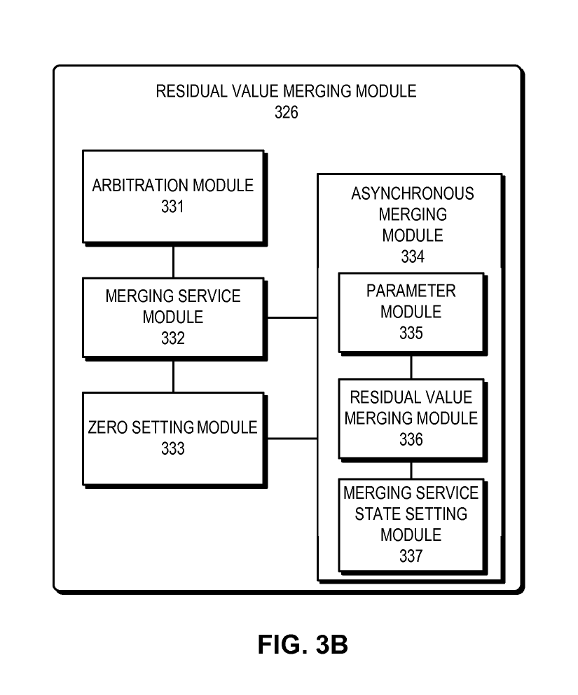

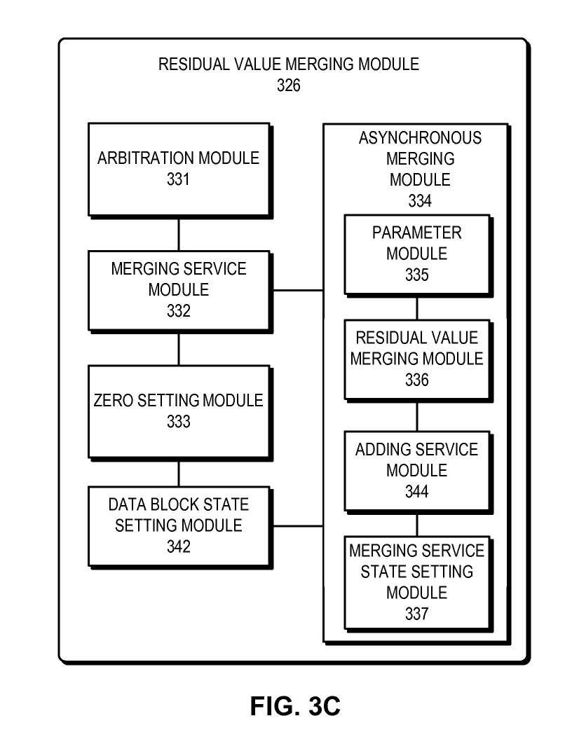

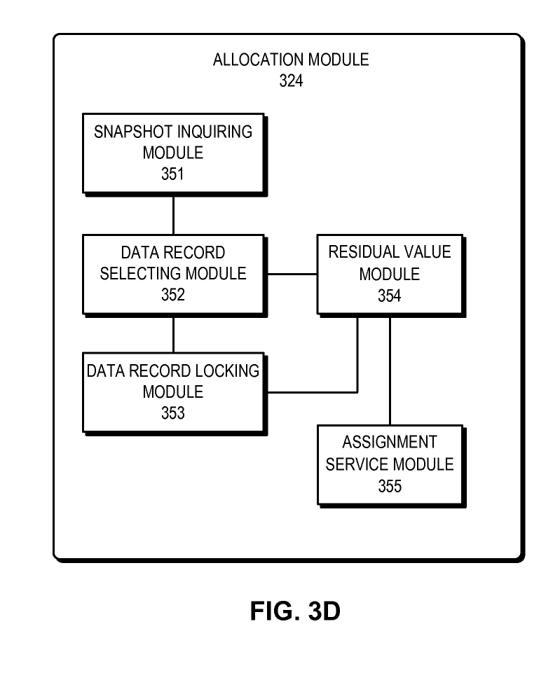

FIG. 3A is a schematic structural diagram of an exemplary residual-value management system, in accordance with an embodiment of the present application. A residual-value management system 300 includes a processor 302, a memory 304, and a storage device 320. Storage device 320 typically stores instructions that can be loaded into memory 304 and executed by processor 302 to perform the methods described above. In one embodiment, the instructions in storage 320 can implement a total value splitting module 322, an assignment module 324, a residual value merging module 326, and a merged sub-value data record generating module 328, all of which can communication with each other through various means.

In some embodiments, modules 322, 324, 326, and 328 can be partially or entirely implemented in hardware and can be part of processor 302. Further, in some embodiments, the system may not include a separate processor and memory. Instead, in addition to performing their specific tasks, modules 322, 324, 326, and 328, either separately or in concert, may be part of special-purpose computation engines.

Storage 320 stores programs to be executed by processor 302. Specifically, storage 320 stores a program that implements a system (application) for efficient residual-value management. During operation, the application program can be loaded from storage 320 into memory 304 and executed by processor 302. As a result, system 300 can perform the functions described above. System 300 can be further coupled to an optional display 312, a keyboard 314, and a pointing device 316, and can be coupled via one or more network interfaces to a network 310.

During operation, total value splitting module 322 splits a total value into a number of sub-values, generates sub-value data records corresponding to respective sub-values, and stores a respective sub-value with a corresponding sub-value data record. Merged sub-value data record generating module 328 selects one of the sub-value data records as a merged sub-value data record. Merged sub-value data record generating module 328 can also generate a merged sub-value data record separate from the sub-value data records. A residual value merging module 326, if the residual value of a sub-value data record is less than or equal to a threshold, merges the residual value of the sub-value data record with the merged sub-value data record, and sets the residual value of the sub-value data record to zero. Assignment module 324 selects one of the sub-value data records with a residual value greater than or equal to the threshold. Allocation module 324 then selects between the selected sub-value data record and the merged sub-value data record for assignment of transactions.

FIG. 3B is a schematic structural diagram of an exemplary residual value merging module of a residual-value management system, in accordance with an embodiment of the present application. Residual value merging module 326 of FIG. 3A can include an arbitration module 331, a merging service module 332, a zero setting module 333, and an asynchronous merging module 334. Arbitration module 331 determines whether the residual value of a sub-value data record is less than (or equal to) the threshold. Merging service module 332 initiates a merging service if the residual value of the sub-value data record is less than (or equal to) the threshold. Zero setting module 333 sets the residual value of the sub-value data record to zero.

Asynchronous merging module 334 initiates and performs an asynchronous merging process. Asynchronous merging module 334 includes a parameter module 335, a residual value merging module 336, and a merging service state setting module 337. Parameter module 335 obtains the parameters, such as a merging value, associated with the merging service. Residual value merging module 336 adds the merging value to the residual value of the merged sub-value data record. Merging service state setting module 337 sets the state of the merging service to indicate that the merging service has been completed.

FIG. 3C is a schematic structural diagram of another exemplary residual value merging module of a residual-value management system, in accordance with an embodiment of the present application. In this example, residual value merging module 326 of FIG. 3A further includes a data record state setting module 342, which sets the state of a sub-value data record as disabled if the residual value of the sub-value data record is zero. Moreover, asynchronous merging module 334 further includes an adding service module 344, which initiates an adding service when the merging value is added to the residual value of the merged sub-value data record. This adding service adds the value indicated by the merging value to the residual value of the merged sub-value data record (i.e., extends the residual value capacity of the merged sub-value data record by the merging value).

FIG. 3D is a schematic structural diagram of an exemplary allocation module of a residual-value management system, in accordance with an embodiment of the present application. Allocation module 324 of FIG. 3A can include a snapshot inquiring module 351, a data record selecting module 352, a data record locking module 353, a residual value module 354, and an assignment service module 355. Snapshot inquiring module 351, during assignment of transactions, inquires the respective snapshots of a sub-value data record and a merged sub-value data record. Data record selecting module 352 selects between the merged sub-value data record and a sub-value data record with an enabled state for transaction assignment. Data record locking module 353, if the sub-value data record is selected, locks the residual value record of the selected sub-value data record. Residual value module 354 assigns the transaction to the selected sub-value data record or the merged sub-value data record. Assignment service module 355 initiates an assignment service.

Referring back to FIG. 3A, in some embodiments, the instructions in storage 320 can further implement one or more of: a database management module 362, a version control module 364, and a snapshot management module 366, all of which can communication with each other through various means. Database management module 362 facilitates the operations associated with the data control system based on a database. Version control module 364 maintains and updates the versions (e.g., version numbers) associated with a respective sub-value data record, and the merged sub-value data record, and their corresponding snapshots. Snapshot management module 366 creates and updates the snapshots of a respective sub-value data record and the merged sub-value data record.

The data structures and computer instructions described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The above description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

What is claimed is:

1. An computer-implemented method for facilitating efficient residual-value management, the method comprising:
storing in a computing system a total value, which corresponds to a total amount of goods or service;
dividing the total value into a number sub-values;
determining that a sub-value is less than or equal to a threshold;
merging the sub-value into a merged residual-value;
receiving a transaction that indicates a subtraction operation with an associated value; and
allowing the merged residual-value to be considered for processing the subtraction operation, thereby reducing residual-value fragmentation.

2. The method of claim 1, wherein the threshold is greater than or equal to a minimum value associated with the subtraction operation.

3. The method of claim 1, further comprising selecting one from the sub-values greater than or equal to the threshold and the merged residual-value for performing the subtraction operation.

4. The method of claim 1, further comprising indicating a sub-value as disabled when a residual value thereof is zero.

5. The method of claim 1, further comprising:
obtaining snapshots of records storing the sub-values and merged residual-value;
selecting a qualified sub-value or the merged residual-value, wherein the snapshot of a qualified sub-value indicates a residual value greater than or equal to the threshold;
responsive to a qualified sub-value being selected, applying a lock to the record storing the selected sub-value and performing the subtraction operation on the selected sub-value.

6. The method of claim 1, further comprising;
maintaining version information for snapshots of records storing the sub-values and merged residual-values; and
updating the version information for the corresponding snapshot when a sub-value or merged residual-value is updated.

7. The method of claim 1, wherein the total value corresponds to an inventory of merchandise;
wherein the transaction is a purchase order for the merchandise; and
wherein the subtraction operation corresponding to the transaction represents a deduction to the inventory as a result of the purchase order.

8. The method of claim 1, wherein the total value corresponds to a total amount of available storage space;
wherein the transaction is a request for allocating a storage space to a user; and
wherein the subtraction operation corresponding to the transaction represents a deduction to the total amount of available storage space as a result of the allocation.

9. A system for facilitating efficient residual-value management, the system comprising:
a processor; and
a storage device coupled to the processor and storing instructions which when executed by the processor cause the processor to perform a method, the method comprising:
storing in a computing system a total value, which corresponds to a total amount of goods or service;
dividing the total value into a number sub-values;
determining that a sub-value is less than or equal to a threshold;
merging the sub-value into a merged residual-value;
receiving a transaction that indicates a subtraction operation with an associated value; and
allowing the merged residual-value to be considered for processing the received subtraction operation, thereby reducing residual-value fragmentation.

10. The system of claim 9, wherein the threshold is greater than or equal to a minimum value associated with the subtraction operation.

11. The system of claim 9, wherein the method further comprises selecting one from the sub-values greater than or equal to the threshold and the merged residual-value for performing the subtraction operation.

12. The system of claim 9, wherein the method further comprises indicating a sub-value as disabled when a residual value thereof is zero.

13. The system of claim 9, wherein the method further comprises:
obtaining snapshots of records storing the sub-values and merged residual-value;
selecting a qualified sub-value or the merged residual-value, wherein the snapshot of a qualified sub-value indicates a residual value greater than or equal to the threshold;
responsive to a qualified sub-value being selected, applying a lock to the record storing the selected sub-value and performing the subtraction operation on the selected sub-value.

14. The system of claim 9, wherein the method further comprises;
maintaining version information for snapshots of records storing the sub-values and merged residual-values; and
updating the version information for the corresponding snapshot when a sub-value or merged residual-value is updated.

15. The system of claim 9, wherein the total value corresponds to an inventory of merchandise;
wherein the transaction is a purchase order for the merchandise; and
wherein the subtraction operation corresponding to the transaction represents a deduction to the inventory as a result of the purchase order.

16. The system of claim 9, wherein the total value corresponds to a total amount of available storage space;
wherein the transaction is a request for allocating a storage space to a user; and
wherein the subtraction operation corresponding to the transaction represents a deduction to the total amount of available storage space as a result of the allocation.

17. A non-transitory storage medium storing instructions which when executed by a processor cause the processor to perform a method, the method comprising:
storing in a computing system a total value, which corresponds to a total amount of goods or service;
dividing the total value into a number sub-values;
determining that a sub-value is less than or equal to a threshold;
merging the sub-value into a merged residual-value;
receiving a transaction that indicates a subtraction operation with an associated value; and
allowing the merged residual-value to be considered for processing the received subtraction operation, thereby reducing residual-value fragmentation.

18. The non-transitory storage medium of claim 17, wherein the threshold is greater than or equal to a minimum value associated with the subtraction operation.

19. The non-transitory storage medium of claim 17, wherein the method further comprises selecting one from the sub-values greater than or equal to the threshold and the merged residual-value for performing the subtraction operation.

20. The non-transitory storage medium of claim 17, wherein the method further comprises indicating a sub-value as disabled when a residual value thereof is zero.
